(19) United States
(12) Patent Application Publication
(10) Pub. No.: US 2010/0307237 A1
(43) Pub. Date: Dec. 9, 2010

(54) FLUID LEVEL SENSOR

(75) Inventor: Dharmaraj Prasad, Tamil Nadu (IN)

Correspondence Address: DANIEL B. SCHEIN, PH.D., ESQ., INC., P. O. BOX 68128, Virginia Beach, VA, 23471, US

(73) Assignee: P.B. No 6331 (l087-A) New No 702/7, Tami Nadu (IN)

(21) Appl. No.: 12/742,438

(22) PCT Filed: Oct. 16, 2008
(86) PCT No.: PCT/IN2008/000682

§ 371 Date: Aug. 25, 2010

(30) Foreign Application Priority Data
Nov. 12, 2007 (IN) 0216/CHE/2007
Sep. 1, 2008 (IN) 02132/CHE/2008

(51) Int. Cl. G01F 23/62

(52) U.S. Cl. 73/313

(57) ABSTRACT

Invention provides for a fluid level sensor with a guide body (10) having a float cavity (62) with a covering (63), which is mounted onto a flange (40). The flange is provided with a rib (51) to increase holding strength. A float (70) which slides along the float cavity (62) when there is a variation of the fluid level. The float cavity (62) makes point contacts with the float (70). A PCB assembly (90) placed along the guide body (10) for fluid level indication, and magnet (71) mounted onto the float (70) activates reed switch (93) of the PCB assembly (90) to indicate the fluid level.

### FIELD OF INVENTION

Fuel level sensor finds application for sensing the level of fuel in a fuel tank. A fuel level sensor comprising grooved aluminium tube, a float (70) with magnet (71), flange (40) with integral connector (41), PCB assembly (90) with Reed Switches and Resistor, Bottom cover (80). The float cavity (62) is in the grooved profile of Aluminium tube, which is rigidly fixed to the flange (40). The PCB Assembly (90) along with reed switches and resistor is connected to the terminals in the integral connector (41) in the flange (40). The float (70) moves up and down based on the fuel level, which in turn activates a particular reed switch by magnetic effect between the magnet in the float (70) and the terminals in the reed switch. Hence the circuit closes up to the particular reed switch. The resistance value against the reed switch is received as the output from the Fuel gauge.

### OBJECTS OF INVENTION

Primary objective of instant invention is to develop a fluid level sensor, comprising a float guide (60) having a float cavity (62) with a covering (63), mounted onto a flange (40) wherein the flange is provided with a rib (51); Still another objective of the present invention is to develop a float (70) which slides along the float cavity (62) during variation of the fluid level, wherein the float cavity (62) makes point contacts with the float (70).

Yet another objective of the present invention is a PCB assembly (90) placed along the float guide (60) for fluid level indication, and magnet (71) mounted onto the float (70) activates reed switch (93) of the PCB assembly (90) to indicate the fluid level.

### STATEMENT OF INVENTION

Instant invention provides for a fluid level sensor, comprising: a guide body (10) having a float cavity (62) with a covering (63), mounted onto a flange (40) wherein the flange is provided with a rib (51), a float (70) which slides along the float cavity (62) during variation of the fluid level, wherein the float cavity (62) makes point contacts with the float (70), a PCB assembly (90) placed along the guide body (10) for fluid level indication, and magnet (71) mounted onto the float (70) activates reed switch (93) of the PCB assembly (90) to indicate the fluid level.

### BRIEF DESCRIPTION OF DRAWINGS

FIG. 1 Shows front perspective view of the Fuel level Sensor

FIG. 2 Shows block drawing of the instant invention with different parts of it

FIG. 3 Shows a reed switch (70)

FIG. 4 Shows view of the Flange (40) with integral connector (41) of the Fuel level Sensor.

FIG. 5 Shows view of the Flange (40) with increased skirt length (50) and extra rib (51).

FIG. 6 Shows perspective view of float guide (60) of the Fuel level Sensor.

FIG. 7 Shows perspective view of the Float Assembly of the Fuel level Sensor.

FIG. 8 Shows perspective view of bottom cover for float guide

FIG. 9 Shows PCB assembly (90) with reed switches and resistors

FIG. 10 Shows a float stopper (100) to restrict the movement of the float

FIG. 11 Shows bottom grommet to restrict flow of fluid in the compartment.

### DETAILED DESCRIPTION OF THE INVENTION

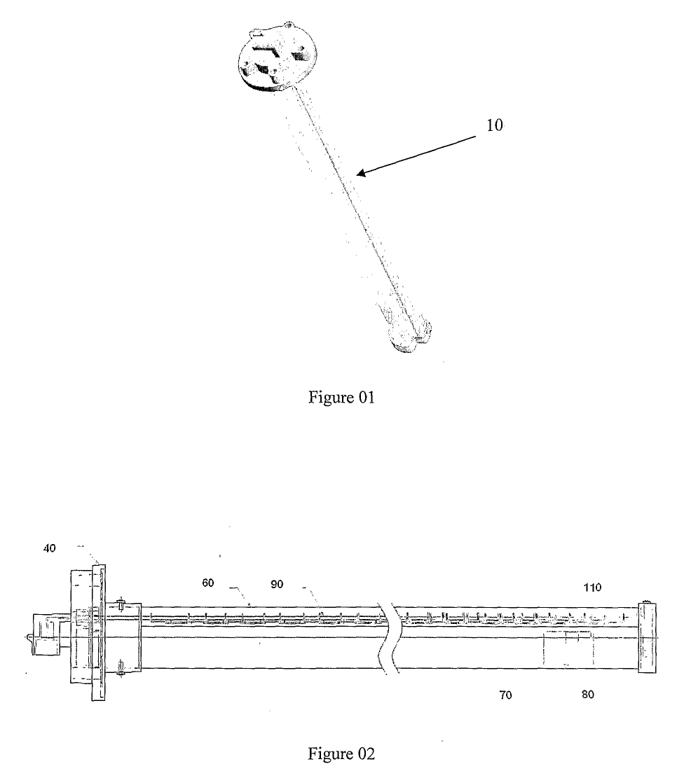

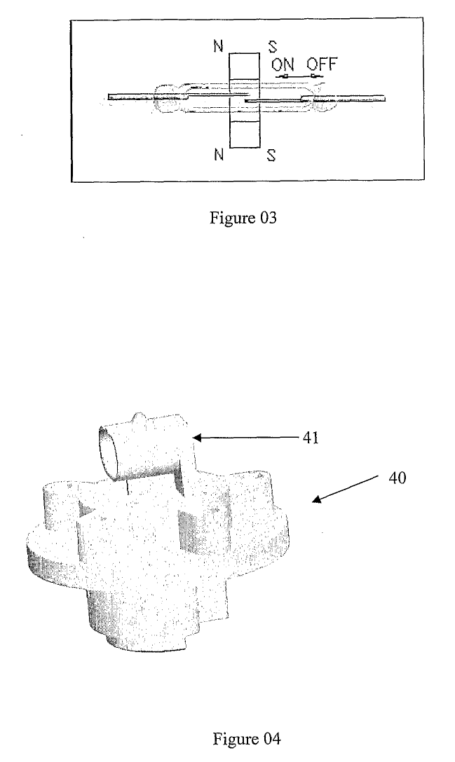

Instant discloser provides for a fluid level sensor finds application for sensing fuel level in a fuel tank. A fluid level sensor of the instant discloser is shown in FIG. 1. The various parts of the fluid level sensor are float guide (60), a float (70) with magnet, flange (40) with integral connector (41), PCB assembly (90) with Reed Switches (91) and Resistors (92), Bottom cover (80) and a grommet (110). The various parts of the fluid level sensor are shown in FIG. 2.

| | |
|---|---|
| Flange | 40 |
| Tube | 60 |
| PCB assembly | 90 |
| Float | 70 |
| Bottom cover | 80 |
| Grommet | 110 |

The guide body (10) shown in FIG. 1 has a float guide (60) which is a grooved profile of Aluminium tube is rigidly fixed to the flange (40). The guide body (10) comprises the Aluminium tube (60) with a float (70) which slides along the tube (60). A PCB assembly (90) having reed switches (91) and resistors (92) which is placed along the length of the float guide (60). The PCB is placed parallel to the Aluminium tube (60). The float (70) carrying a magnet is so designed such that it would not rotate when it is in the float cavity (62). The PCB assembly (90) along with reed switches and resistors is connected to the terminals in the integral connector (41) in the flange (40). The float moves up and down based on the fuel level, which in turn activates a particular reed switch by magnetic effect between the magnet in the float and the terminals in the reed switch. Hence the circuit closes up to the particular reed switch. The resistance value against the reed switch is received as the output from the Fuel gauge.

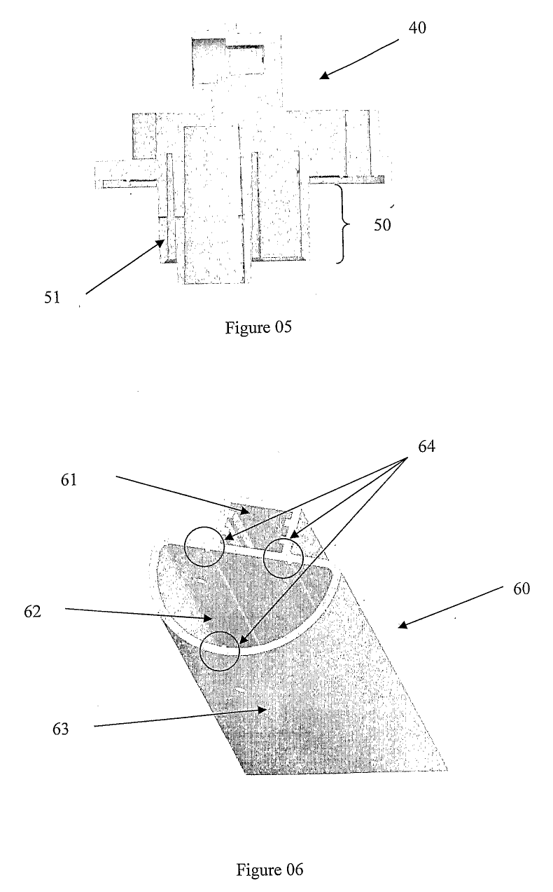

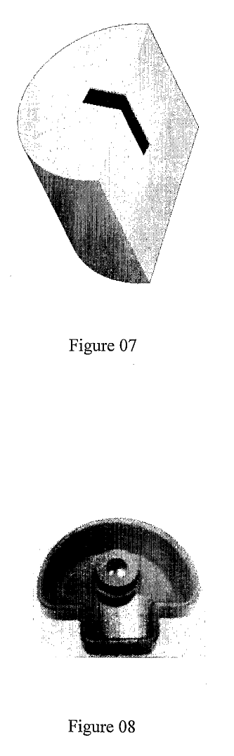

The guide body (10) is fixed to a flange (40) as shown in FIGS. 4 and 5, where the flange (40) is provided with the integral connector (41). The purpose of the integral connector (41) is to ease the routing the wiring assembly in the assembly fitment. This connector (41) has connection with wires from the PCB of the PCB assembly (90) internally. Further the flange (40) skirt length (50) and extra rib (51) as shown in FIG. 5 is so provided to increase the holding strength of the guide body (10) to withstand resonance frequency. During vehicle movement due to vibration in 3 directions (x, y, z) the fuel level sensor get resonance frequency which will affect/damage the sensor. To avoid any failure/damage of fuel level sensor additional rib is provided in the flange (40) to withstand the required resonance frequency. Resonance frequency is around 70 Hz.

Float guide (60) as shone in FIG. 6 has a float cavity (62) provided for the float to slide along the float guide. The float cavity (62) makes point contact with the float. The point contacts (64) are as shown in the FIG. 6. The illustration example in the FIG. 6 shows a float guide (60) with 3 point contacts provided for the float along the length of the float cavity. These point contacts helps in reducing the amount of friction, wear and tear due to surface contact of the float with the float cavity. Smooth movement of the float along the float guide (60) is also assured due to point contacts. Further, problems due to introduction of foreign particles, if any, in to the cavity (62) will not hinder the float movement since the float is in point contact with the float cavity. The float cavity (62) is formed by the covering (63) completely covers the float in its path. The cavity (62) thus provides protection to the float which could be damaged during installation time. This also helps in reducing the variation of the float level due to splashing of the fluid on the float or ripples created in the fluid. This is one of the common problems seen in the application of fluid level sensors for vehicles subject to wild fluctuations in the fluid level due to movement of the vehicle in rough terrain.

The float guide (60) as shown in FIG. 6 has a compartment (61) were the PCB is inserted. Guide ribs are provided in the compartment (61) to fix the PCB in tact. The float guide (60) is so designed such that it forms the skeleton for the float cavity (62) and the compartment (61) thus reducing the amount of material required to manufacture the float guide (60). This compartment (61) (54) is provided with sufficient space for the PCB assembly (90) to fit in. The float guide (60) is made up of Aluminium or plastic or poly acetal like Delrin based on the requirements of the flexi fuel.

The float (70) is fitted with a magnet (71). The float is designed to have blind cavity and not a through cavity to fix the magnet (71). This is having an advantage to fix the magnet in the ideal position and more rigid. The float contour is designed to make point contact instead of surface contact with the float cavity (62) to avoid friction/wear in the float movement. The float is made out of hard rubber sponge using 14 chemical compositions bonding to have compatible with flexi fuel. The composition is varied in such a way that it suits the requirement of the flexi fuel. The length and the width of the float so designed that it moves along the cavity (62) with no rotation of the float relative to the guide (60) in the path. The float is loosely placed in the cavity (62).

The compartment (61) in the float guide (60) is provided with a bottom grommet (110) as shown in FIG. 11. This restricts the fuel entry into the compartment. In addition to this the float guide (60) is provided with a bottom cover (80) (see FIG. 8) to stop the float movement outside the float cavity (62). This cover has a provision provided in it for fuel to enter in to the float cavity (62). An opening (81) is provided though which fluid enters in to the float cavity (62) which will lift the float. Because of small opening in the bottom cover for the fluid to enter it also helps in reducing the variation of the float level due to splashing of the fluid on the float or ripples created in the fluid. The opening can be optionally fitted with filters to prohibit foreign bodies entering the float cavity (62).

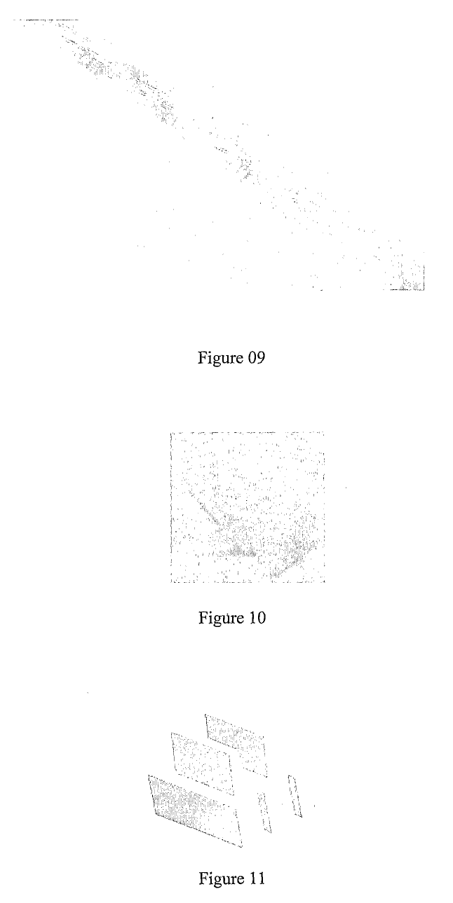

FIG. 9 shows the PCB assembly (90) having reed switches and resistors arranged on it. Distance at which each reed switch is place on the PCB determines the resolution of the fuel level sensor. The reed switches and resistors are placed directly proportional to twice the mounting angle of reed switch position to have relevant activation of reed switch without interruption between to and fro values.

Optionally float stopper or plug (100) as shown in FIG. 10 is provided in the float cavity (62) to restrict the movement of the float above a certain height from the bottom side.

Conventional sensing devices for use in sensing the liquid level in fuel tanks includes a tube having separate cavity for PCB assembly (90) and a grooved path for movement of float assembly.

This invention relates to tubular fuel level sensors for use with vehicle fuel tanks such as Car, LCV, HCV, off road vehicle, snowmobiles, etc. An indicating instrument will be used in conjunction with the fuel sensor to read the fuel level in the tank.

### Advantages of Reed Switch:

Reed switches are hermetically sealed in glass environment, free from contamination, and are safe to use in harsh industrial and explosive environments.
Reed switches are immune to electrostatic discharge (ESD) and do not require any external ESD protection circuits.
The isolation resistance between the contacts is as high as 1015 ohms, and contact resistance is as low as 50 milliohms.
Reed switches can directly switch loads as low as a few microwatts without needing external amplification circuits, to as high as 120 W.

1-8. (canceled)

9. A fluid level sensor, comprising:
a float guide having a float cavity with a covering, mounted onto a flange having integrated connector wherein the flange is provided with a rib,
a float which slides along the float cavity during variation of the fluid level, wherein the float cavity is provided with plurality of point contacts along the length of float cavity to make point contact with the float,
a PCB assembly placed along the float guide for fluid level indication wherein the PCB assembly is connected to the integrated connector, and
a magnet mounted onto the float activates reed switch of the PCB assembly to indicate the fluid level.

10. The fluid level sensor as claimed in claim 1, wherein the float guide is provided with a compartment for placing a PCB assembly.

11. The fluid level sensor as claimed in claims 1, wherein the float guide is provided with a bottom grommet for the compartment to restrict fluid entry.

12. The fluid level sensor as claimed in claim 1, wherein the float guide is provided with bottom cover to stop the float movement out side the float cavity.

13. The fluid level sensor as claimed in claim 12, wherein the bottom cover provides an opening for fluid to flow.

14. The fluid level sensor as claimed in claim 9, wherein the float cavity provides for three point contacts.

15. The fluid level sensor as claimed in claim 9, wherein the float cavity is provided with a plug to restrict the movement of the float.

16. The fluid level sensor as claimed in claim 10, wherein the float guide is provided with a bottom grommet for the compartment to restrict fluid entry.
